(19) United States
(12) Patent Application Publication
(10) Pub. No.: US 2017/0142645 A1
(43) Pub. Date: May 18, 2017

(54) METHOD FOR ENHANCING PERFORMANCE OF A COMMUNICATIONS APPARATUS IN A PLMN SEARCH PROCEDURE AND A COMMUNICATIONS APPARATUS UTILIZING THE SAME

(71) Applicant: MEDIATEK INC., Hsin-Chu (TW)

(72) Inventors: Kun-Lin WU, Taoyuan City (TW); Hung-Lin CHANG, Taipei City (TW); Chih-Hung LEE, Kaohsiung City (TW); Yuh-Hwang YOU, New Taipei City (TW); Ming LEE, Taichung City (TW); Yu-Cheng HUANG, Taipei City (TW)

(21) Appl. No.: 15/335,579

(22) Filed: Oct. 27, 2016

Related U.S. Application Data
(60) Provisional application No. 62/254,233, filed on Nov. 12, 2015.

(51) Int. Cl. H04W 48/16; H04W 48/18

(52) U.S. Cl. CPC H04W 48/16; H04W 48/18

(57) ABSTRACT

A communications apparatus includes a radio transceiver, a memory device and a processor. The radio transceiver transmits or receives wireless radio frequency signals to or from an air interface. The memory device stores a registration database including one or more sets of registration data. Each set of registration data corresponds to an International Mobile Subscriber Identity (IMSI). The processor determines whether performing a PLMN search procedure is required, and when performing a PLMN search procedure is required, the processor retrieves suitable registration data from the registration database according to a currently used IMSI and performs the PLMN search procedure via the radio transceiver based on the retrieved suitable registration data.

### CROSS REFERENCE TO RELATED APPLICATIONS

This application claims the benefit of U.S. Provisional Application No. 62/254,233 filed 2015 Nov. 12 entitled “Multiple RPLMN with IMSI to speed up PLMN selection” the entire contents of which are hereby incorporated by reference.

### BACKGROUND OF THE INVENTION

Field of the Invention

The invention relates to methods for enhancing performance of a communications apparatus in a PLMN search procedure.

Description of the Related Art

A public land mobile network (PLMN) is a regulatory term in the field of telecommunications that refers to a network that is operated for the purpose of providing land mobile communication services to the public. A PLMN is identified by a Mobile Country Code (MCC) and a Mobile Network Code (MNC). Access to PLMN services is achieved by means of an air interface involving radio communications between mobile phones, or other wireless enabled user equipment (UE), and land based radio transmitters or radio base stations (BS).

Conventionally, a PLMN search procedure at the user equipment (UE) may take a relatively long time to complete (e.g., several minutes). Especially, when a full-band scan is performed during the PLMN search procedure. The duration of the PLMN search may depend on the number of frequency bands or radio access technologies (RATs) supported by the UE, and the more frequency bands/RATs supported, the longer it may take to complete the PLMN search procedure.

To speed up the PLMN search procedure, methods for enhancing the performance of a communications apparatus in a PLMN search procedure are required.

### BRIEF SUMMARY OF THE INVENTION

Communications apparatus and methods for enhancing performance of a communications apparatus in a PLMN search procedure are provided. An exemplary embodiment of a communications apparatus comprises a radio transceiver, a memory device and a processor. The radio transceiver transmits or receives wireless radio frequency signals to or from an air interface. The memory device stores a registration database comprising one or more sets of registration data. Each set of registration data corresponds to an International Mobile Subscriber Identity (IMSI). The processor determines whether performing a PLMN search procedure is required, and when performing a PLMN search procedure is required, the processor retrieves suitable registration data from the registration database according to a currently used IMSI and performs the PLMN search procedure via the radio transceiver based on the retrieved suitable registration data.

An exemplary embodiment of a method for enhancing performance of a communications apparatus in a PLMN search procedure comprises: storing a registration database in a memory device of the communications apparatus, wherein the registration database comprises one or more sets of registration data, and wherein each set of registration data corresponds to an International Mobile Subscriber Identity (IMSI); determining whether performing a PLMN search procedure is required; when performing a PLMN search procedure is required, retrieving suitable registration data from the registration database according to a currently used IMSI; and performing the PLMN search procedure based on the retrieved suitable registration data.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary block diagram of a modem according to an embodiment of the invention;

FIG. 3 is an exemplary diagram showing a message flow when performing the location registration in a 2G/3G network;

FIG. 4 is another exemplary diagram showing a message flow when performing the location registration in a 4G network;

FIG. 5 shows an exemplary data structure of the registration database stored in a memory device of the communications apparatus according to an embodiment of the invention;

FIG. 6 is a flow chart of a method for enhancing performance of a communications apparatus in a PLMN search procedure according to an embodiment of the invention;

FIG. 7 is a flow chart of a method for retrieving the suitable registration data from the registration database according to an embodiment of the invention; and

FIG. 8 is a flow chart of a method for maintaining the registration database according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

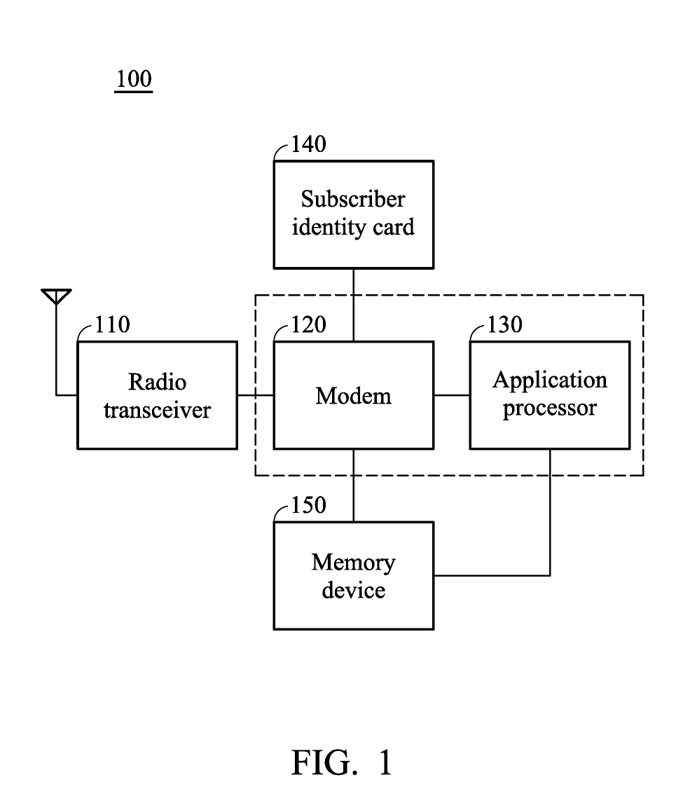

FIG. 1 shows an exemplary block diagram of a communications apparatus according to an embodiment of the invention. The communications apparatus 100 may be a portable electronic device, such as a Mobile Station (MS, which may be interchangeably referred to as User Equipment (UE)). The communications apparatus 100 may comprise at least an antenna module comprising at least one antenna, a radio transceiver 110, a modem 120, an application processor 130, a subscriber identity card 140, and a memory device 150. The radio transceiver 110 may receive wireless radio frequency signals from an air interface via the antenna module, transmit wireless radio frequency signals to the air interface via the antenna module and perform RF signal processing. For example, the radio transceiver 110 may convert the received signals to intermediate frequency (IF) or baseband signals to be processed, or receive the IF or baseband signals from the modem 120 and convert the received signals to wireless radio frequency signals to be transmitted to a network device. According to an embodiment of the invention, the network device may be a cell, an evolved node B, a base station, a Mobility Management Entity (MME) etc., at the network side and communicating with the communications apparatus 100 via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portions of the RF signals and/or a mixer for performing radio frequency conversion. According to an embodiment of the invention, the radio frequency may be, for example, 900 MHz or 1800 MHz for a Global System for Mobile communication (GSM), or 1900 MHz for a Universal Mobile Telecommunications System (UMTS), or the frequency of any specific frequency band for a Long-Term Evolution (LTE) system, etc.

The modem 120 may be a cellular communications modem configured for handling cellular system communications protocol operations and processing the IF or baseband signals received from or to be transmitted to the radio transceiver 110. The application processor 130 is configured for running the operating system of the communications apparatus 100 and running application programs installed in the communications apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory device 150 may be coupled to the modem 120 and application processor 130 and may store system data or user data.

Note that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1. In another example, in some embodiments of the invention, the communications apparatus may further comprise a central controller coupled to the modem 120 and the application processor 130. Therefore, the invention should not be limited to what is shown in FIG. 1.

Note further that although FIG. 1 shows a single-card single-standby application, the invention should not be limited thereto. For example, in some embodiments of the invention, the communications apparatus may comprise multiple subscriber identity cards to support multiple radio access technologies (RATs) communications. In the multiple RATs communications applications, the modem, the radio transceiver and/or the antenna module may be shared by the subscriber identity cards and may have the capability of handling the operations of multiple cellular system communications protocols and processing the corresponding RF, IF or baseband signals in compliance with multiple cellular system communications protocols. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention. Therefore, in some embodiments of the invention, the communications apparatus may be designed to support a multi-card multi-standby application by making some alterations and modifications.

Note further that the subscriber identity card 140 may be dedicated hardware cards as described above, or in some embodiments of the invention, there may be individual identifiers, numbers, addresses, or the like which are burned in the internal memory device of the corresponding modem and are capable of identifying the communications apparatus. Therefore, the invention should not be limited to what is shown in the figures.

Note further that in some embodiments of the invention, the communications apparatus may further support multiple IMSIs.

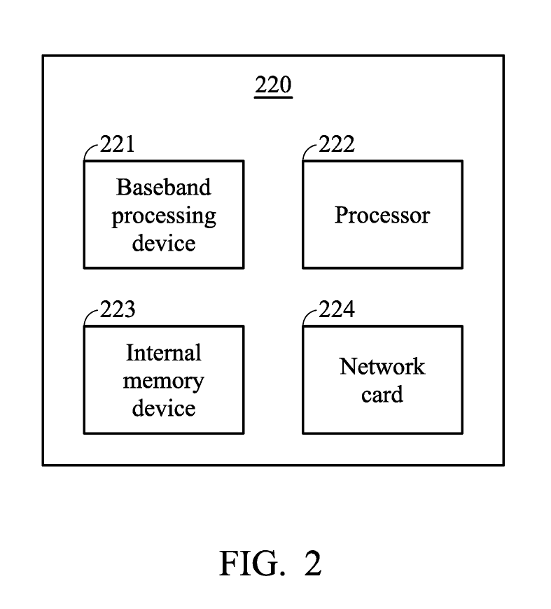

FIG. 2 shows an exemplary block diagram of a modem according to an embodiment of the invention. The modem 220 may be the modem 120 shown in FIG. 1 and may comprise at least a baseband processing device 221, a processor 222, an internal memory device 223 and a network card 224. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140, and write data to the subscriber identity card. The internal memory device 223 may store system data and user data for the modem 220. The processor 222 may also access the internal memory device 223.

The network card 224 provides Internet access services for the communications apparatus. Note that although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. Therefore, the invention should not be limited to any specific implementation method.

Note further that, in order to clarify the concept of the invention, FIG. 2 presents simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

In 3GPP specifications TS 22.011 and TS 23.122, it is specified that “At switch on, or following recovery from lack of coverage, the MS selects the registered PLMN (RPLMN) or equivalent PLMN (EPLMN) using all access technologies that the MS is capable of and if necessary attempts to perform a Location Registration” and “As an alternative option to this, if the MS is in automatic network selection mode and it finds coverage of an equivalent home PLMN (EHPLMN), the MS may register to that EHPLMN and not return to the registered PLMN or equivalent PLMN. If the EHPLMN list is not present or is empty, and the home PLMN (HPLMN) is available, the MS may register on the HPLMN and not return to the registered PLMN or equivalent PLMN”.

Following the 3GPP specifications, in automatic network selection mode, the UE shall select and attempt registration on other PLMNs in the following order:

1. An EHPLMN if the EHPLMN list is present or the HPLMN (derived from the International Mobile Subscriber Identity (IMSI)) if the EHPLMN list is not present for preferred access technologies in the order specified.

2. Each entry in the “User Controlled PLMN Selector with Access Technology” data field in the SIM/USIM (in priority order).

3. Each entry in the “Operator Controlled PLMN Selector with Access Technology” data field in the SIM/USIM (in priority order).

4. Other PLMN/access technology combinations with sufficient received signal quality in random order.

5. All other PLMN/access technology combinations in order of decreasing signal quality.

In brief, as defined by the 3GPP specifications, the UE shall select and attempt registration on the PLMN strictly in the following order:

1. Last registered PLMN (or alternatively, HPLMN),

2. HPLMN,

3. User-preferred PLMN,

4. Operator-preferred PLMN,

5. Other high-quality PLMN in random order,

6. All the other PLMN in decreasing signal quality.

Generally, in a PLMN search procedure, the UE selects a PLMN based on the priority as illustrated above and attempts registration on the selected PLMN. For example, the UE may first try to register to the last RPLMN or a HPLMN. The UE may scan the frequencies to receive wireless radio frequency signals from a network device at a specific frequency. The UE may decode the broadcast system information carried in the wireless radio frequency signals to obtain information regarding a PLMN ID corresponding to the network device, and determine whether the PLMN ID corresponding to the network device matches the PLMN ID of the last RPLMN or the HPLMN. When the PLMN ID matches the PLMN ID of the last RPLMN or the HPLMN, the UE may stop scanning the frequencies and perform a location registration to try to register to the last RPLMN or the HPLMN. When the location registration succeeds, the PLMN search procedure is terminated.

When the PLMN ID does not match the PLMN ID of the last RPLMN or the HPLMN, or the location registration fails, the UE keeps scanning the frequencies as illustrated above until a PLMN ID match and a successful location registration occur.

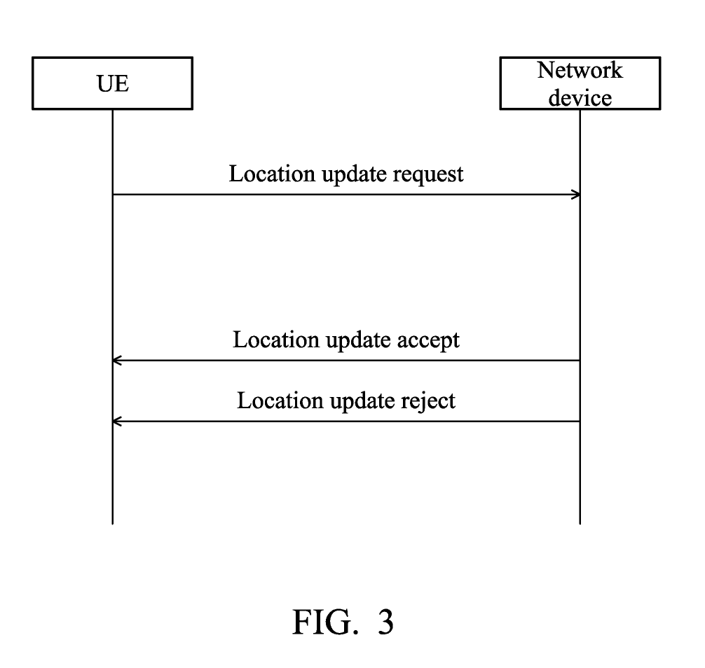

FIG. 3 is an exemplary diagram showing a message flow when performing the location registration in a 2G/3G network. The UE may send a location update request to the network device. Upon receiving the location update request, the network device may accept the request and send a location update accept to the UE or reject the request and send a location update reject to the UE.

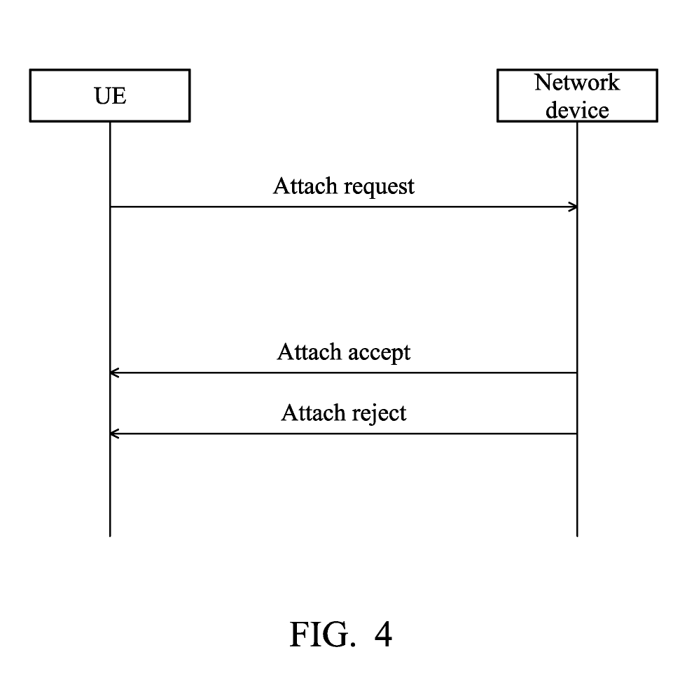

FIG. 4 is another exemplary diagram showing a message flow when performing the location registration in a packet switch (e.g. 4G) network. The UE may send an attach request to the network device. Upon receiving the attach request, the network device may accept the request and send an attach accept to the UE or reject the request and send an attach reject to the UE.

However, if there is neither an RPLMN match nor an HPLMN match, the UE has to perform a full-band scan during the PLMN search procedure. The full-band scan is a very time-consuming and power-consuming procedure since the UE has to scan all frequency bands or radio access technologies (RATs) supported by the UE.

To avoid performing a full-band scan in the PLMN search procedure, methods for enhancing performance of a communications apparatus in a PLMN search procedure are proposed.

According to an embodiment of the invention, the communications apparatus (e.g. the communications apparatus 100 shown in FIG. 1) may maintain a registration database comprising one or more sets of registration data. The registration database may be stored in a memory device (e.g. the memory device 150 shown in FIG. 1 or the internal memory device 223 shown in FIG. 2) of the communications apparatus.

According to an embodiment of the invention, each set of registration data corresponds to an International Mobile Subscriber Identity (IMSI).

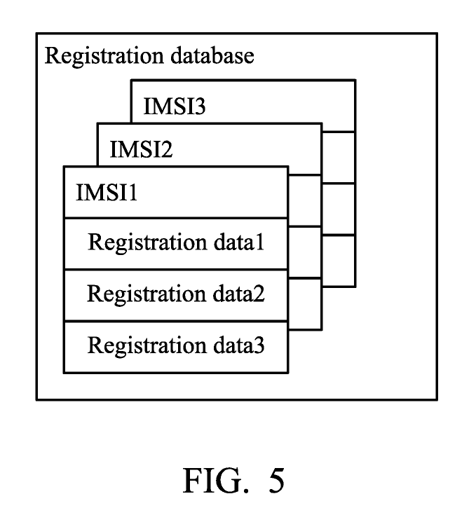

FIG. 5 shows an exemplary data structure of the registration database stored in a memory device of the communications apparatus according to an embodiment of the invention. As shown in FIG. 5, the registration database may comprise one or more sets of registration data, each corresponding to one IMSI. For example, the set of registration data corresponding to IMSI1 may comprise registration data 1, registration data 2, and registration data 3 . . . etc.

According to an embodiment of the invention, when performing a PLMN search procedure is required (for example when the communications apparatus is powering on, attempting to recover service, after IMSI switch when the communications apparatus supports multiple IMSIs, hot unplugging/plugging a subscriber identity card in the communications apparatus, or others), the processor (e.g. the processor 222 shown in FIG. 2) may retrieve suitable registration data from the registration database according to a currently used IMSI and perform the PLMN search procedure via the radio transceiver (e.g. the radio transceiver 110 shown in FIG. 1) based on the retrieved suitable registration data.

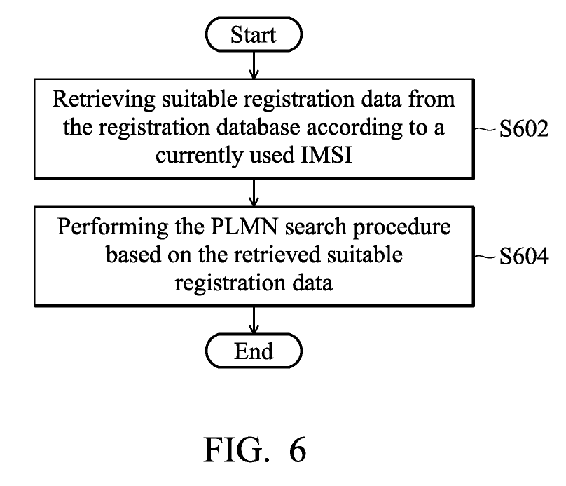

FIG. 6 is a flow chart of a method for enhancing performance of a communications apparatus in a PLMN search procedure according to an embodiment of the invention. As discussed above, when performing a PLMN search procedure is required, the processor may retrieve suitable registration data from the registration database according to a currently used IMSI (Step S602), and perform the PLMN search procedure based on the retrieved suitable registration data (Step S604).

According to an embodiment of the invention, information regarding the currently used IMSI may be obtained by reading a corresponding field of the subscriber identity card (e.g. the subscriber identity card 140 shown in FIG. 1). According to another embodiment of the invention, when the communications apparatus supports multiple IMSIs, information regarding the currently used IMSI may be derived based on the IMSI of the subscriber identity card, and/or other parameters.

According to an embodiment of the invention, the set of registration data may comprise a PLMN ID of a registered PLMN. For example, once the communications apparatus has successfully registered to a PLMN, the PLMN ID of that PLMN may be added as the registration data corresponding to the currently used IMSI in the registration database. In another example, once the communications apparatus fails to register to a PLMN, the PLMN ID of that PLMN may also be added as one registration data corresponding to the currently used IMSI in the registration database. The PLMN ID of the PLMN involved in a failed registration may have a special mark or flag to distinguish it from the PLMN ID of the PLMN involved in a successful registration.

Note that, conventionally, there is at most one RPLMN available from the SIM card. Information regarding the RPLMN can be obtained from the EF_LOCI, EF_GLOCI and/or EF_EPSLOCI fields of the SIM card. Once location registration fails, the information record in the EF_LOCI, EF_GLOCI and EF_EPSLOCI fields of the SIM card is deleted. When there is no RPLMN information record in the SIM card or the RPLMN information is not suitable (for example, when the communications apparatus is roaming in a foreign country) and there is also no PLMN in the current network environment that matches the HPLMN of the SIM card, a serious performance downgrade occurs since in this situation, a full-band scan has to be performed.

Unlike the conventional design, in the embodiments of the invention, a plurality of sets of registration data can be stored in the memory device of the communications apparatus. With the information obtained from the previous registration, a full-band scan can be avoided and the time and power consumption required for a PLMN search procedure can be greatly reduced. In this manner, the communications apparatus can get normal service faster than the conventional design. For example, the communications apparatus can get normal service within just 3-5 seconds.

According to an embodiment of the invention, the set of registration data may further comprise a location area code (LAC) corresponding to the registered PLMN, a routing area code (RAC) corresponding to the registered PLMN, a tracking area code (TAC) corresponding to the registered PLMN and/or a cell ID of a camped-on cell. According to another embodiment of the invention, the set of registration data may further comprise location information, and/or a registration result of the communications apparatus when a location registration has previously been performed.

According to an embodiment of the invention, the location information of the communications apparatus may be the longitude and the latitude of the communications apparatus when a location registration has previously been performed.

According to an embodiment of the invention, in Step S602, the processor may retrieve the suitable registration data by selecting a set of registration data that corresponds to an IMSI which is the same as the currently used IMSI and records a PLMN ID which is the same as a PLMN ID corresponding to a camped-on cell. The camped-on cell may be either a currently camped-on cell or a previously camped-on cell.

According to another embodiment of the invention, in Step S602, the processor may retrieve the suitable registration data by selecting a set of registration data that corresponds to an IMSI which is the same as the currently used IMSI and records a PLMN ID which has a mobile country code (MCC) that is the same as a MCC corresponding to a camped-on cell. The camped-on cell may be either a currently camped-on cell or a previously camped-on cell.

According to another embodiment of the invention, in Step S602, the processor may retrieve the suitable registration data by selecting a set of most recent registration data that corresponds to an IMSI which is the same as the currently used IMSI.

Note that in the embodiments of the invention, the suitable registration data utilized for performing the PLMN search procedure in step S604 may comprise information regarding one or more PLMNs selected as illustrated above. Therefore, in the embodiments of the invention, in step S604, the PLMN search procedure may be performed based on the information regarding one or more PLMNs retrieved from the registration database, which is also different from the conventional design.

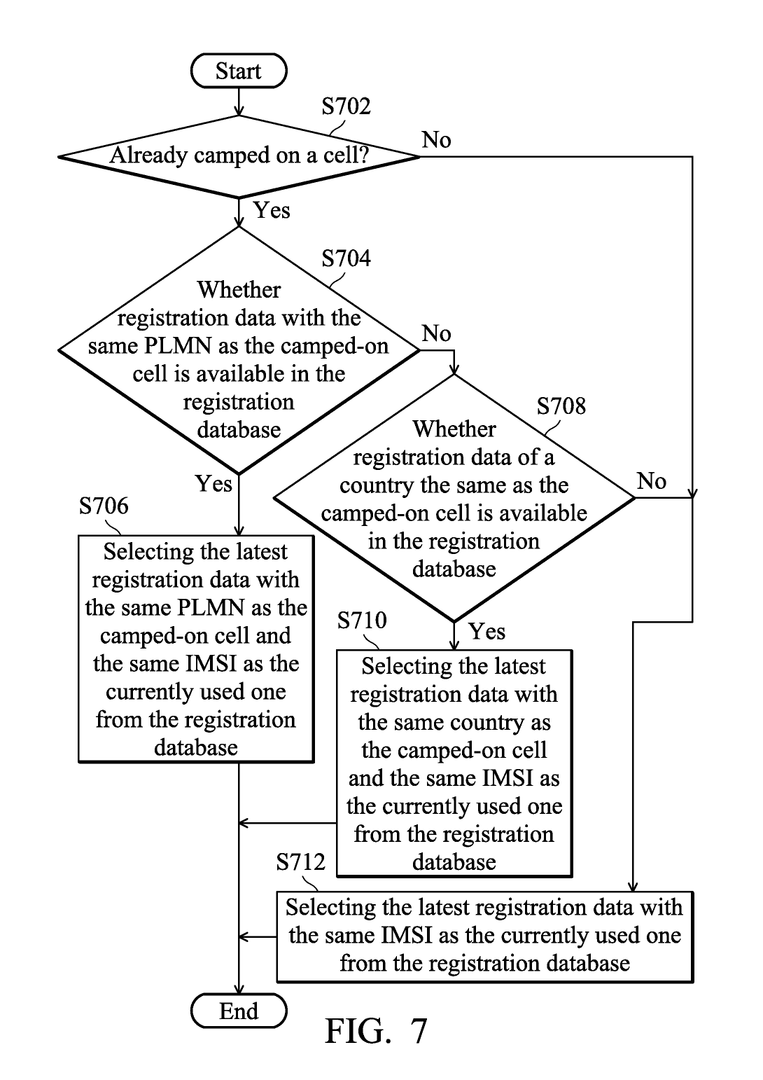

FIG. 7 is a flow chart of a method for retrieving the suitable registration data from the registration database according to an embodiment of the invention. The processor may first determine whether communications apparatus already camped on a cell (Step S702). When the communications apparatus has already camped on a cell, the signaling between the communications apparatus and the cell is synchronized. If so, the processor may further determine whether registration data with PLMN the same as the camped-on cell and IMSI the same as the currently used one is available in the registration database (Step S704). If so, the processor may select the latest registration data with the same PLMN and the same IMSI as the currently used one from the registration database (Step S706).

When there is no registration data with PLMN the same as the camped-on cell is available in the registration database, the processor may further determine whether registration data of a country the same as the camped-on cell and IMSI the same as the currently used one is available in the registration database (Step S708). If so, the processor may select the latest registration data with the same country as the camped-on cell and the same IMSI as the currently used one from the registration database (Step S710).

When the communications apparatus does not camp on a cell, or there is no registration data of a country the same as the camped-on cell is available in the registration database, the processor may select the latest registration data with the same IMSI as the currently used one from the registration database (Step S712).

According to an embodiment of the invention, the processor may further perform a location registration, as the message flows shown in FIG. 3 and FIG. 4, to register to a PLMN in the PLMN search procedure, and update the registration database according to a registration result obtained from the location registration.

In an example, when the location registration succeeds, the processor may add a set of registration data corresponding to the currently used IMSI in the registration database as a set of most recent registration data corresponding to the currently used IMSI, or update a set of registration data that corresponds to an IMSI which is the same as the currently used IMSI and records a PLMN ID that is the same as the ID of the PLMN involved in the location registration in the registration database as a set of most recent registration data corresponding to the currently used IMSI.

In another example, when the location registration fails, the processor may delete a set of registration data that corresponds to an IMSI which is the same as the currently used IMSI and records a PLMN ID that is the same as the ID of the PLMN involved in the location registration, or update a set of registration data that corresponds to an IMSI which is the same as the currently used IMSI and records a PLMN ID that is the same as the ID of the of the PLMN involved in the location registration in the registration database according to the registration result.

As discussed above, the set of registration data may comprise the PLMN ID of a registered PLMN, LAC, RAC, TAC, cell ID, location information, and/or the registration result of the communications apparatus.

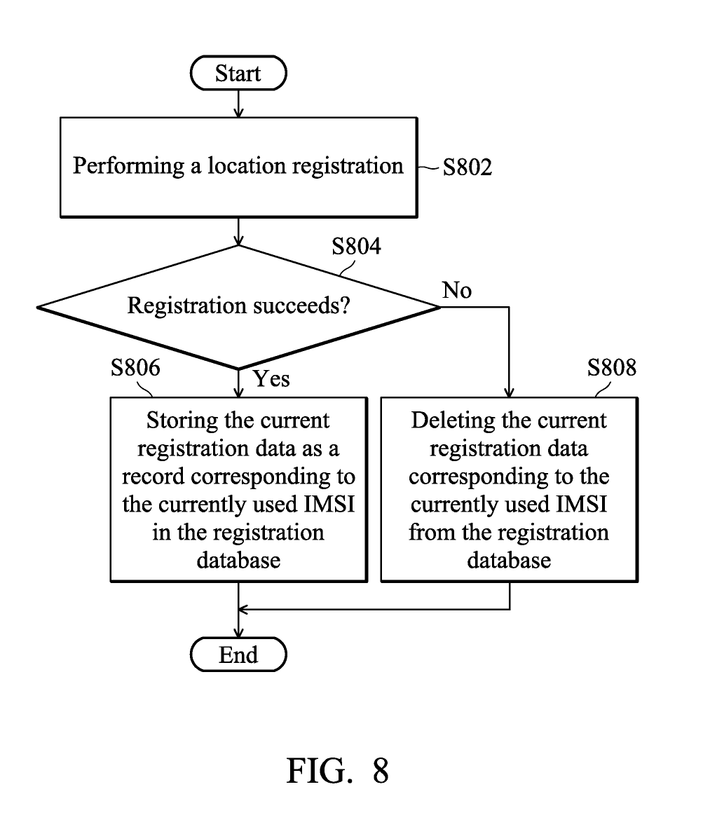

FIG. 8 is a flow chart of a method for maintaining the registration database according to an embodiment of the invention. After performing a location registration (Step S802), the processor may determine whether the registration succeeds (Step S804). When the registration succeeds, the processor may store the current registration data (for example, the RPLMN ID, LAC, RAC, TAC, cell ID, location information, and so on) as a record corresponding to the currently used IMSI in the registration database (Step S806). When the registration fails, the processor may delete the current registration data corresponding to the currently used IMSI from the registration database if it exists (Step S808).

According to another embodiment of the invention, the registration database may also be updated by other ways. For example, the registration database may be dynamically updated over the air (OTA) by a network device, periodically updated by a registration server in the network or based on the information obtained from the registration server, or others.

As discussed above, unlike the conventional design, in the embodiments of the invention, a plurality of sets of registration data can be stored in the memory device of the communications apparatus. With the information obtained from the previous registration, a full-band scan can be avoided and the time and power consumption required by the PLMN search procedure can be greatly reduced. In this manner, the communications apparatus can get normal service faster than the conventional design. For example, the communications apparatus can get normal service within just 3-5 seconds.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a radio transceiver, capable of transmitting or receiving wireless radio frequency signals to or from an air interface;
a memory device, storing a registration database comprising one or more sets of registration data, wherein each set of registration data corresponds to an International Mobile Subscriber Identity (IMSI); and
a processor, determining whether performing a PLMN search procedure is required, and when performing a PLMN search procedure is required, retrieving suitable registration data from the registration database according to a currently used IMSI and performing the PLMN search procedure via the radio transceiver based on the retrieved suitable registration data.

2. The communications apparatus as claimed in claim 1, wherein the set of registration data comprises a PLMN ID of a registered PLMN.

3. The communications apparatus as claimed in claim 2, wherein the set of registration data further comprises a location area code (LAC) corresponding to the registered PLMN, a routing area code (RAC) corresponding to the registered PLMN, a tracking area code (TAC) corresponding to the registered PLMN, a cell ID of a camped-on cell, location information, and/or a registration result of the communications apparatus when a location registration has previously been performed.

4. The communications apparatus as claimed in claim 1, wherein the processor retrieves the suitable registration data by selecting a set of registration data that corresponds to an IMSI which is the same as the currently used IMSI and records a PLMN ID which is the same as a PLMN ID corresponding to a camped-on cell.

5. The communications apparatus as claimed in claim 1, wherein the processor retrieves the suitable registration data by selecting a set of registration data that corresponds to an IMSI which is the same as the currently used IMSI and records a PLMN ID which has a mobile country code (MCC) that is the same as a MCC corresponding to a camped-on cell.

6. The communications apparatus as claimed in claim 1, wherein the processor retrieves the suitable registration data by selecting a set of most recent registration data that corresponds to an IMSI which is the same as the currently used IMSI.

7. The communications apparatus as claimed in claim 1, wherein the processor further performs a location registration to register to a PLMN in the PLMN search procedure, and updates the registration database according to a registration result.

8. The communications apparatus as claimed in claim 7, wherein the processor further adds or updates a set of most recent registration data when the location registration succeeds.

9. The communications apparatus as claimed in claim 7, wherein when the location registration fails, the processor further deletes a set of registration data that corresponds to an IMSI which is the same as the currently used IMSI and records a PLMN ID which is the same as a PLMN ID of the PLMN involved in the location registration.

10. A method for enhancing performance of a communications apparatus in a PLMN search procedure, comprising:
storing a registration database in a memory device of the communications apparatus, wherein the registration database comprises one or more sets of registration data, and wherein each set of registration data corresponds to an International Mobile Subscriber Identity (IMSI);
determining whether performing a PLMN search procedure is required;
when performing a PLMN search procedure is required, retrieving suitable registration data from the registration database according to a currently used IMSI; and
performing the PLMN search procedure based on the retrieved suitable registration data.

11. The method as claimed in claim 10, wherein the set of registration data comprises a PLMN ID of a registered PLMN that the communications apparatus registered to.

12. The method as claimed in claim 11, wherein the set of registration data further comprises a location area code (LAC) corresponding to the registered PLMN, a routing area code (RAC) corresponding to the registered PLMN, a tracking area code (TAC) corresponding to the registered PLMN, a cell ID of a camped-on cell that the communications apparatus has camped on, location information, and/or a registration result of the communications apparatus when a location registration has previously been performed.

13. The method as claimed in claim 10, wherein the step of retrieving suitable registration data from the registration database according to a currently used IMSI comprises:
selecting a set of registration data that corresponds to an IMSI which is the same as the currently used IMSI and records a PLMN ID which is the same as a PLMN ID corresponding to a camped-on cell.

14. The method as claimed in claim 10, wherein the step of retrieving suitable registration data from the registration database according to a currently used IMSI comprises:
selecting a set of registration data that corresponds to an IMSI which is the same as the currently used IMSI and records a PLMN ID which has a mobile country code (MCC) that is the same as a MCC corresponding to a camped-on cell.

15. The method as claimed in claim 10, wherein the step of retrieving suitable registration data from the registration database according to a currently used IMSI comprises:
selecting a set of most recent registration data that corresponds to an IMSI which is the same as the currently used IMSI.

16. The method as claimed in claim 10, further comprising:
performing a location registration to register to a PLMN in the PLMN search procedure; and
updating the registration database according to a registration result.

17. The method as claimed in claim 16, further comprising:
adding or updating a set of most recent registration data when the location registration succeeds.

18. The method as claimed in claim 16, further comprising:
when the location registration fails, deleting a set of registration data that corresponds to an IMSI which is the same as the currently used IMSI and records a PLMN ID which is the same as a PLMN ID of the PLMN involved in the location registration.
